(19) United States
(12) Patent Application Publication
(10) Pub. No.: US 2024/0028971 A1
(43) Pub. Date: Jan. 25, 2024

(54) Machine Learning of Probability Distributions Through a Generalization Error

(71) Applicant: type20 AI, LLC, Weston, MA (US)

(72) Inventor: Keith Hartt, Weston, MA (US)

(21) Appl. No.: 17/813,403

(22) Filed: Jul. 19, 2022

(51) Int. Cl. G06N 20/20; G06N 5/00

(52) U.S. Cl. CPC G06N 20/20; G06N 5/003

(57) ABSTRACT

A computer-implemented method provides functionality for training a machine learning model, while a machine learning system supports training and using such a model to accurately approximate a probability distribution based upon an obtained set of real-world data. The model may be formed based on a data mapping that associates an input data point to a respective output data point. The probability distribution may be initially estimated from the real-world data by determining a base ensemble of binary decision trees. The initial distribution may subsequently be automatically improved by proposing changes to the ensemble of binary decision trees and evaluating generalization error for the initial and changed ensembles using a training dataset, and a holdover data set complementary to the training dataset, obtained by randomly sorting elements of the real-world data.

### BACKGROUND

Machine learning is a rapidly growing field with seemingly endless applications. Automobiles, for example, are being designed with features ranging from active safety controls to full self-driving capabilities, in order to more safely and efficiently deliver occupants to desired destinations. In another example, medical diagnostic equipment is being improved such that adverse health conditions such as cancer can be detected at earlier stages, leading to improved prognoses for patients. At the heart of any example of a machine learning system is the data from which machine learning models are trained. Such data, once obtained from an environment in which a machine learning system operates, can be examined in any number of ways such that humans and machines alike can learn a great deal about such an environment. Discovering increasingly effective ways of examining data is thus a subject of intense research in the realm of machine learning, leading to increasingly accurate and versatile machine learning models.

### SUMMARY

Embodiments of the present invention address the shortcomings in the art. In particular, embodiments provide a computer-implemented method and system of training a machine learning model. The method accesses a given machine learning model. The given machine learning model may be formed based on a data mapping. The data mapping associates an input data point to a respective output data point. From empirical data of interest for the given machine learning model, the method estimates a probability distribution and automatically improves the estimated probability distribution using a generalization error. The step of improving the estimated probability distribution is implemented by a digital processor: (i) modeling the probability distribution using a decision tree ensemble (i.e., a set or group of decision trees), and (ii) optimizing choice of tree in the decision tree ensemble by minimizing the generalization error. The follow-on improved estimated probability distribution determines weights or parameters for the given machine learning model resulting in a trained model.

In embodiments, the method step of estimating the probability distribution includes: from the empirical data, obtaining a data set including a plurality of samples and storing the data set within a computer memory element. The method further configures the processor to: (i) determine randomly a base ensemble of binary decision trees. The method step of automatically improving the estimated probability distribution may include further configuring the processor to: (ii) determine and thereby propose a changed ensemble of randomized binary decision trees; (iii) randomly sort samples of the plurality of samples within the computer memory element to define a training set and a holdout set complementary to the training set; and (iv) evaluate using the training and holdout sets from step (iii) a base generalization error of the proposed base ensemble of binary decision trees; (v) evaluate using the training and holdout sets from step (iii) a new generalization error of the proposed changed ensemble of binary decision trees; (vi) in response to the new generalization error being less than the base generalization error designate, within the computer memory element, the proposed changed ensemble of binary decision trees as the new base ensemble of binary decision trees; and (vii) repeat steps (ii)-(vi) according to a pre-determined constant number of training iterations, thereby optimizing the base ensemble of binary decision trees based on generalization error thereof. The optimized base ensemble of binary decision trees represents the automatically improved estimated probability distribution.

In some embodiments of the method, respective randomized binary decision trees of the base ensemble thereof have a number of decision layers that is influenced by a pre-determined maximum number of samples allowed within leaf nodes of the randomized binary decision trees. The method may further include configuring the processor to: (viii) repeat steps (ii)-(vi) wherein the number of decision layers is influenced by a reduced maximum number of samples allowed within the leaf nodes of the binary decision trees, such that the proposed changed ensemble of randomized binary decision trees has a greater number of decision layers than the number of decision layers in the base ensemble of randomized binary decision trees.

In some embodiments, the method further includes configuring the processor to: (ix) recursively repeat step (viii) until the computed new generalization error is smaller than the designated base generalization error for a pre-determined number of iterations, thereby increasing the number of decision layers in the base ensemble of randomized binary decision trees until an optimized generalization error is reached.

In some embodiments, the method includes, before respectively designating the proposed changed ensemble of binary decision trees as the base ensemble of binary decision trees, configuring the processor to store the base ensemble of binary decision trees as elements of an entry in a historical database within the computer memory element. The historical database may be configured to retain a pre-determined number of entries. The method may include configuring the processor to respectively designate the elements of a selected entry as the base ensemble of binary decision trees, thereby returning the probability model to a previously estimated state for further optimization therefrom.

In some embodiments, proposing a base ensemble of randomized binary decision trees includes: (a) defining a binary decision tree having a root node, a plurality of branches and a plurality of decision nodes corresponding to the plurality of branches. The decision nodes may include a plurality of intermediate decision nodes and a plurality of leaf nodes. The branches may initially radiate from the root node and be mutually connected by the intermediate decision nodes. Pairs of the branches may correspond to pairs of opposing evaluations of respective inequalities instructive of a comparison between any sample from the training set and a random threshold value assigned to the given pair of branches. Proposing a base ensemble of randomized binary decision trees may further include: (b) assigning a given training sample from the training set to individual leaf nodes of the plurality of leaf nodes by passing the given training sample from the root node along selected branches determined by the evaluations of the respective inequalities for the given training sample at successive selected branches. Proposing a base ensemble of randomized binary decision trees may further include: (c) repeating step (b) for each sample in the training set; and (d) repeating steps (b) and (c) until a pre-determined number of decision trees has been met, thereby producing a base ensemble of randomized binary decision trees.

In some embodiments, evaluating a base generalization error includes: (a) computing respective point estimates for each leaf node of the plurality of leaf nodes of a given randomized binary decision tree based on the samples from the training set assigned to the leaf node. Evaluating a base generalization error may further include (b) assigning a given test sample from the holdout set to individual leaf nodes of the plurality of leaf nodes by passing the given test sample from the root node along selected branches determined by evaluations of the respective inequalities for the given test sample at successive selected branches. Evaluating a base generalization error may further include (c) repeating steps (a) and (b) for each test sample in the holdout set; (d) repeating steps (a) through (c) for each randomized binary decision tree in the base ensemble thereof, and (e) computing a sum, over each randomized binary decision tree in the base ensemble thereof, of squared differences between a first value and a second value. The first value may be a probability of having correctly, according to output values of samples of the holdout set, assigned the samples of the holdout set to individual leaf nodes based on input values of the holdout set. The second value may be unity.

In some embodiments, proposing a changed ensemble of randomized binary decision trees includes: (a) defining a change to a randomly selected random threshold value of a given pair of branches. Proposing a changed ensemble of randomized binary decision trees may further include (b) assigning a given training sample from the new training set to individual leaf nodes of the plurality of leaf nodes by passing the given training sample from the root node along selected branches determined by the evaluations of the respective inequalities for the given training sample at successive selected branches. Proposing a changed ensemble of randomized binary decision trees may further include (c) repeating step (b) for each sample in the training set, and (d) repeating steps (b) and (c) until the pre-determined number of decision trees has been met, thereby producing a changed ensemble of randomized binary decision trees.

In some embodiments, evaluating a new generalization error includes: (a) computing respective point estimates for each leaf node of the plurality of leaf nodes of a given randomized binary decision tree based on the samples from the new training set assigned to the leaf node. Evaluating a new generalization error may further include (b) assigning a given test sample from the new holdout set to individual leaf nodes of the plurality of leaf nodes by passing the given test sample from the root node along selected branches determined by evaluations of the respective inequalities for the given test sample at successive selected branches. Evaluating a new generalization error may further include (c) repeating steps (a) and (b) for each test sample in the new holdout set, (d) repeating steps (a) through (c) for each randomized binary decision tree in the proposed changed ensemble thereof, and (e) computing a sum, over the leaf nodes of each randomized binary decision tree in the proposed changed ensemble thereof, of squared differences between a first value and a second value. The first value may be a probability of having correctly, according to output values of samples of the new holdout set, assigned the samples of the new holdout set to individual leaf nodes based on input values of the holdout set. The second value may be unity.

In some embodiments, the method further includes computing a measure of variability based on the samples assigned to the leaf nodes of the base ensemble of binary decision trees. The measure of variability may be at least one of variance, standard deviation, range, and interquartile range.

In some embodiments, a machine learning system includes a processor and a computer memory area with computer-executable software instructions stored thereon. The instructions, when loaded by the processor, may cause the processor to be configured to access a given machine learning model stored in computer memory. The given machine learning model may be formed based on a data mapping. The data mapping may associate an input data point to a respective output data point. The instructions, when loaded, may further configure the processor to estimate a probability distribution from empirical data of interest for the given machine learning model. The instructions, when loaded, may further configure the processor to automatically improve the estimated probability distribution using a generalization error by modeling the probability distribution using a decision tree ensemble, and optimizing choice of tree in the decision tree ensemble by minimizing the generalization error. The improved estimated probability distribution may determine weights or parameters for the given machine learning model resulting in a trained model.

Through the processor, the computer software instructions, and computer memory storing the given machine learning model or access to the same, embodiments of the system may be configured to perform or embody any one or combination of the methods described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic view of a computer network in which embodiments of the present invention may be deployed.

FIG. 2 is a block diagram of a computer node (client, server) in the computer network of FIG. 1.

FIG. 3A is a flow diagram of a method of training a machine learning model using a generalization error according to example embodiments.

FIG. 3B is a flow diagram of a method of estimating a probability distribution that may be used in an embodiment of a method of training a machine learning model using a generalization error.

FIG. 4 is a block diagram of a machine learning system embodying the present invention.

FIG. 5 is a plot of an example machine learning model dataset with a corresponding interpolation surface drawn to represent expected values of a probability distribution based on the example dataset.

FIG. 6 is a graphical depiction of a binary tree fit to the example data set of FIG. 5 in embodiments.

FIGS. 7-9 are plots of the example dataset of FIG. 5 with corresponding estimation surfaces of subsequently increasing levels of resolution approached by embodiments.

### DETAILED DESCRIPTION

A description of example embodiments follows.

A rapidly expanding field of applications has pervaded the machine learning development community in recent years. Systems such as self-driving automobiles and medical diagnostic tools have become increasingly adept at processing streams of data and making decisions based on the data that can ultimately have a profound effect on human lives. However, various deficiencies persist in machine learning systems and in processes for training such systems. Neural nets, for example, may be effectively used to fit a function to a set of data by employing thresholds to force binary decisions, but such a function may fall short of predicting how datasets describing future events may take shape. It is therefore desirable for a machine learning system to instead fit an entire probability distribution to a given set of data. Embodiments of the present disclosure seek to address such shortcomings in the art.

Decision trees provide a basis for machine learning systems to derive functions from data, but may also be used to estimate probability distributions from said data, for example, according to the present disclosure. Decision trees implement thresholds such that an element of data is evaluated according to an inequality defining the threshold, and the element of data moves along one branch of the tree or another depending upon whether it is evaluated to be greater than or less than the threshold value. The element of data may be subjected to subsequent inequalities and associated branch selections until it terminates at a node of the tree designated as a leaf node. A set of data with a plurality of elements may thus be organized in a tree of various layers. Such a set of data may include, for example, diameter or density data of distinct regions of tissue in medical images. A machine learning system may be trained with a distinct set of inequalities and branches such that potential malignancy of such regions of tissue may be determined based on the diameter or density data. Machine learning systems such as these may be endowed with greater accuracy and efficiency when trained according to the present disclosure.

### Computer Support

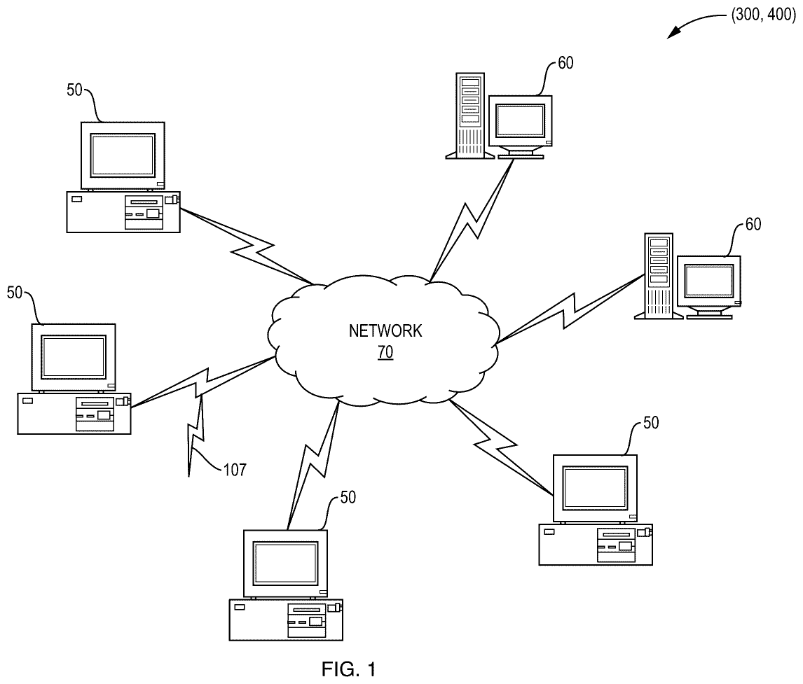

FIG. 1 illustrates a computer network or similar digital processing environment in which embodiments 300, 400 of the present invention may be implemented. Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

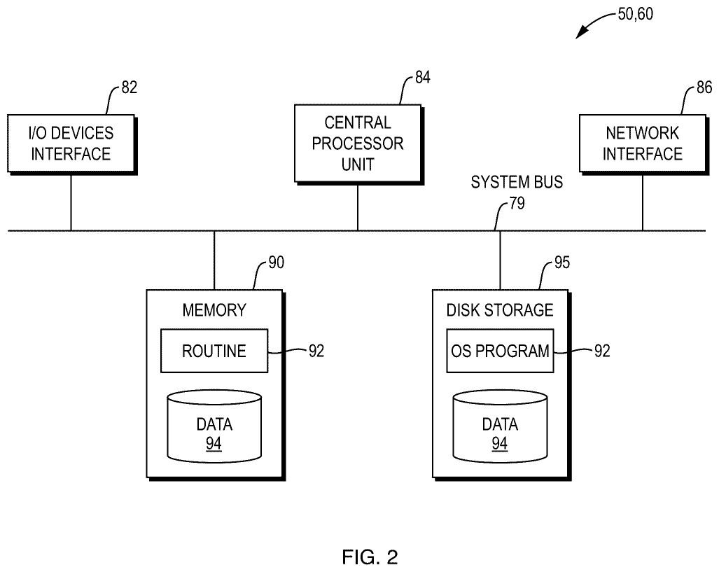

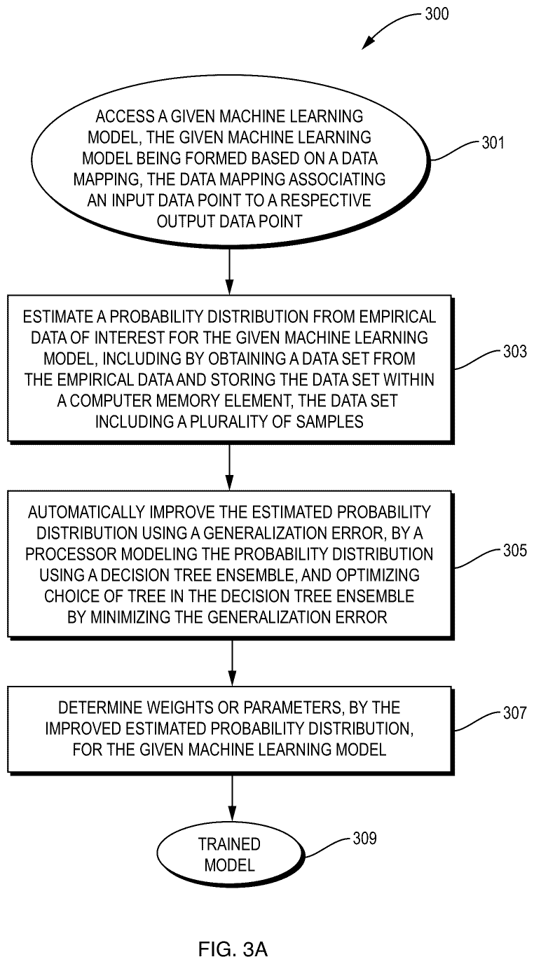

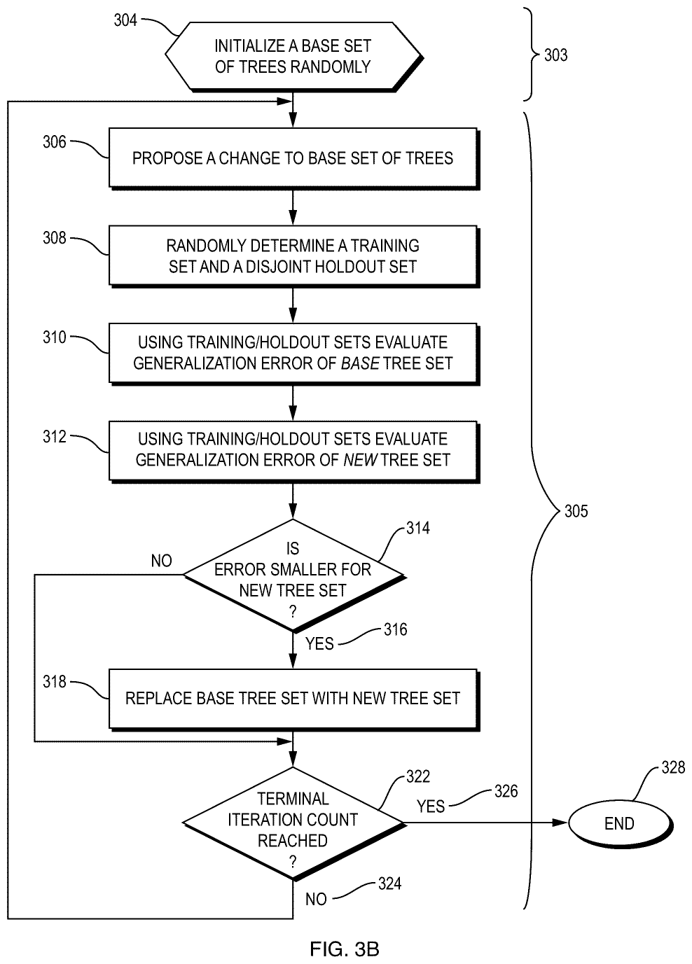

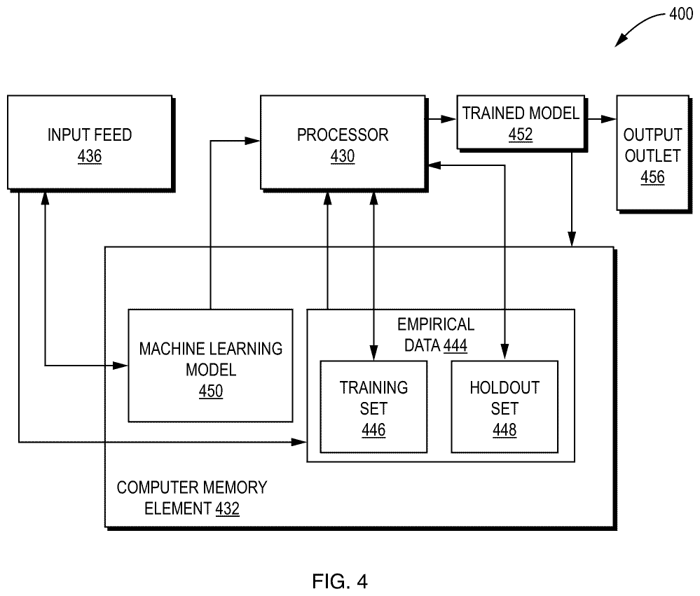

FIG. 2 is a diagram of the internal structure of a computer (e.g., client processor/device 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions 92 and data 94 used to implement an embodiment of the present invention (e.g., the machine learning model training method, system, techniques, and program code detailed below in FIGS. 3A, 3B, and 4). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

In other embodiments, the program product 92 may be implemented as a so called Software as a Service (SaaS), or other installation or communication supporting end-users.

### EXAMPLE EMBODIMENTS

With reference to FIGS. 3A, 3B, and 4, embodiments employ a generalization error to improve training of machine learning models as heretofore unachieved in the prior art. An iterative process 300 by which such generalization error is reduced is portrayed in FIG. 3A. Further detail as to an estimation step 303 of process 300 is depicted in FIG. 3B. As shown by way of overview in FIG. 4, a machine learning system 400 as applied to a subject of interest includes an input feed 436, a training data set (i.e., training set) 446, a holdout data set (i.e., a holdout set) 448, a machine learning model 450, and an output outlet 456.

In particular, embodiments provide a computer-implemented method and system. A computer-implemented method 300 of training a machine learning model accesses 301 a given machine learning model, the given machine learning model being formed based on a data mapping. The data mapping associates an input data point to a respective output data point. From empirical data of interest for the given machine learning model, the method estimates 303 a probability distribution and automatically improves 305 the estimated probability distribution using a generalization error. The step of improving the estimated probability distribution is implemented by a digital processor: (i) modeling the probability distribution using a decision tree ensemble, and (ii) optimizing choice of tree in the decision tree ensemble by minimizing the generalization error. The follow-on improved estimated probability distribution determines 307 weights or parameters for the given machine learning model resulting in a trained model 309.

In embodiments, the method step of estimating 303 the probability distribution includes: from the empirical data, obtaining a data set including a plurality of samples and storing the data set within a computer memory element. The method step of estimating 303 further configures the processor to: (i) determine randomly a base ensemble of binary decision trees 304. In these embodiments, the method step of automatically improving 305 the estimated probability distribution includes further configuring the processor to: (ii) determine and thereby propose 306 a changed ensemble of randomized binary decision trees; (iii) randomly sort 308 samples of the plurality of samples within the computer memory element to define a training set and a holdout set complementary to the training set; and (iv) evaluate using the training and holdout sets from step (iii) a base generalization error of the proposed base ensemble of binary decision trees 310; (v) evaluate using the training and holdout sets from step (iii) a new generalization error of the proposed changed ensemble of binary decision trees 312; (vi) in response 316 to the new generalization error being less than 314 the base generalization error designate 318, within the computer memory element, the proposed changed ensemble of binary decision trees as the new base ensemble of binary decision trees; and (vii) repeat 324 steps (ii)-(vi) according to 326 a pre-determined constant number 322 of training iterations, thereby optimizing 328 the base ensemble of binary decision trees based on generalization error thereof. The optimized base ensemble of binary decision trees represents the automatically improved estimated probability distribution.

In some embodiments, a machine learning system 400 includes a processor 430 and a computer memory element 432. The machine learning system 400 may support a model that can be trained according to aspects of the present disclosure, such as according to the method 300. The system 400 further includes an input feed 436 configured to obtain information pertaining to a machine learning model 450, and empirical data 444, and store the model 450 and data 444 within the computer memory element. The computer memory element may include computer-executable software instructions that, when loaded by the processor 430, cause the processor to be configured to access the machine learning model 450 stored in the computer memory element 432. The machine learning model 450 may be formed based on a data mapping. Such a data mapping may associate an input data point to a respective output data point. The processor 430 may be further configured to access empirical data 444 for the machine learning model 450 and to estimate a probability distribution from the empirical data 444.

In such embodiments, the processor 430 may be further configured to automatically improve the estimated probability distribution using a generalization error. The action of automatic improvement may include the processor 430 modeling the probability distribution using a decision tree ensemble, and optimizing choice of tree in the decision tree ensemble by minimizing the generalization error. The action of automatic improvement may include determining and thereby proposing 306 a changed ensemble of randomized binary decision trees. The action of automatic improvement may include randomly sorting 308 samples of the plurality of samples of the empirical data 444 within the computer memory element 432 to define a training set 446 and a holdout set 448 complementary to the training set 446. The action of automatic improvement may further include evaluating, using the training 446 and holdout 448 sets, a base generalization error 310 of the proposed base ensemble 304 of binary decision trees, and a new generalization error 312 of the proposed changed ensemble 306 of binary decision trees. If the new generalization error is less than the base generalization error, the action of automatic improvement may include replacing, within the computer memory element 432, the existing proposed base ensemble 306 of binary decision trees with the proposed changed ensemble 308 of binary decision trees, and thus designating 318 the proposed changed ensemble 308 of binary decision trees as a new base ensemble of binary decision trees.

The action of automatic improvement may accordingly be repeated 322 for a pre-determined constant number of training iterations. In such a way, the processor may be configured to determine weights or parameters for the machine learning model, resulting in a trained model 452, which may be stored in the computer memory element 432 in addition to, or in place of, the original machine learning model 450. Alternatively, or in addition, the trained model may issue as an output from the machine learning system 400 via an output outlet 456, and may thus be employed by devices, modules, or systems connected with or otherwise relating to the machine learning system 400.

Continuing with respect to the system 400, the computer memory element 432 may be configured to store a data set obtained from the empirical data 444. Such a data set may include a plurality of samples. The processor 430 may be configured to estimate the probability distribution by (i) determining randomly a base ensemble of binary decision trees. The processor 430 may be configured to automatically improve the estimated probability distribution by (ii) determining and thereby proposing a changed ensemble of randomized binary decision trees, (iii) randomly sorting samples of the plurality of samples within the computer memory element 432 to define a training set 446 and a holdout set 448 complementary to the training set 446, (iv) evaluating using the training 446 and holdout 448 sets from step (iii) a base generalization error of the proposed base ensemble of binary decision trees, (v) evaluating using the training 446 and holdout 448 sets from step (iii) a base generalization error of the proposed base ensemble of binary decision trees, (vi) if the new generalization error is less than the base generalization error designating, within the computer memory element 432, the proposed changed ensemble of binary decision trees as the new base ensemble of binary decision trees, and (vii) repeating steps (ii)-(vi) according to a pre-determined constant number of training iterations, thereby optimizing the base ensemble of binary decision trees based on generalization error thereof. The optimized base ensemble of binary decision trees may represent the automatically improved estimated probability distribution, from which the trained model 452 may be derived as described hereinabove.

Returning to a consideration of the example method 300 of training a machine learning model, in some embodiments, respective randomized binary decision trees of the base ensemble thereof have a number of decision layers that is influenced by a pre-determined maximum number of samples allowed within leaf nodes of the randomized binary decision trees. The method 300 may further include configuring the processor 430 to: (viii) repeat the steps of proposing 306 a changed ensemble, randomly sorting 308 samples to define a training set (e.g., training set 446) and a holdout set (e.g., holdout set 448), evaluating a base generalization error 310 and a new generalization error 312, and designating 318 the proposed changed ensemble of binary decision trees as the new base ensemble of binary decision trees. Such repetition of the aforementioned steps may be performed while the number of decision layers is influenced by a reduced maximum number of samples allowed within the leaf nodes of the binary decision trees. Such an influence may cause the proposed changed ensemble of randomized binary decision trees to have a greater number of decision layers than the number of decision layers in the base ensemble of randomized binary decision trees.

In some embodiments, the method 300 further includes configuring the processor 430 to, in a second level of recursion, iterate the repetition of the aforementioned steps until the computed new generalization error is smaller than the designated base generalization error for a pre-determined number of iterations, thereby increasing the number of decision layers in the base ensemble of randomized binary decision trees until an optimized generalization error is reached.

In some embodiments, the method 300 includes, before respectively designating 318 the proposed changed ensemble of binary decision trees as the base ensemble of binary decision trees, configuring the processor 430 to store the base ensemble of binary decision trees as elements of an entry in a historical database within the computer memory element 432. The historical database may be configured to retain a pre-determined number of entries. The method 300 may include configuring the processor 430 to respectively designate the elements of a selected entry as the base ensemble of binary decision trees, thereby returning the probability model to a previously estimated state for further optimization therefrom.

In some embodiments, proposing a base ensemble of randomized binary decision trees 304 includes: (a) defining a binary decision tree having a root node, a plurality of branches and a plurality of decision nodes corresponding to the plurality of branches. The decision nodes may include a plurality of intermediate decision nodes and a plurality of leaf nodes. The branches may initially radiate from the root node and be mutually connected by the intermediate decision nodes. Pairs of the branches may correspond to pairs of opposing evaluations of respective inequalities instructive of a comparison between any sample from the training set 446 and a random threshold value assigned to the given pair of branches. Proposing a base ensemble of randomized binary decision trees 304 may further include: (b) assigning a given training sample from the training set 446 to individual leaf nodes of the plurality of leaf nodes by passing the given training sample from the root node along selected branches determined by the evaluations of the respective inequalities for the given training sample at successive selected branches. Proposing a base ensemble of randomized binary decision trees 304 may further include: (c) repeating step (b) for each sample in the training set 446; and (d) repeating steps (b) and (c) until a pre-determined number of decision trees has been met, thereby producing a base ensemble of randomized binary decision trees 304.

In some embodiments, evaluating a base generalization error 310 includes: (a) computing respective point estimates for each leaf node of the plurality of leaf nodes of a given randomized binary decision tree based on the samples from the training set 446 assigned to the leaf node. Evaluating a base generalization error may further include (b) assigning a given test sample from the holdout set 448 to individual leaf nodes of the plurality of leaf nodes by passing the given test sample from the root node along selected branches determined by evaluations of the respective inequalities for the given test sample at successive selected branches. Evaluating a base generalization error 310 may further include (c) repeating steps (a) and (b) for each test sample in the holdout set 448; (d) repeating steps (a) through (c) for each randomized binary decision tree in the base ensemble thereof; and (e) computing a sum, over each randomized binary decision tree in the base ensemble thereof, of squared differences between a first value and a second value. The first value may be a probability of having correctly, according to output values of samples of the holdout set 448, assigned the samples of the holdout set to individual leaf nodes based on input values of the holdout set 448. The second value may be unity.

In some embodiments, proposing a changed ensemble of randomized binary decision trees 306 includes: (a) defining a change to a randomly selected random threshold value of a given pair of branches. Proposing a changed ensemble of randomized binary decision trees 306 may further include (b) assigning a given training sample from the new training set to individual leaf nodes of the plurality of leaf nodes by passing the given training sample from the root node along selected branches determined by the evaluations of the respective inequalities for the given training sample at successive selected branches. Proposing a changed ensemble of randomized binary decision trees 306 may further include (c) repeating step (b) for each sample in the training set, and (d) repeating steps (b) and (c) until the pre-determined number of decision trees has been met, thereby producing a changed ensemble of randomized binary decision trees 306.

In some embodiments, evaluating a new generalization error 312 includes: (a) computing respective point estimates for each leaf node of the plurality of leaf nodes of a given randomized binary decision tree based on the samples from the new training set assigned to the leaf node. Evaluating a new generalization error 312 may further include (b) assigning a given test sample from the new holdout set to individual leaf nodes of the plurality of leaf nodes by passing the given test sample from the root node along selected branches determined by evaluations of the respective inequalities for the given test sample at successive selected branches. Evaluating a new generalization error 312 may further include (c) repeating steps (a) and (b) for each test sample in the new holdout set, (d) repeating steps (a) through (c) for each randomized binary decision tree in the proposed changed ensemble thereof, and (e) computing a sum, over the leaf nodes of each randomized binary decision tree in the proposed changed ensemble thereof, of squared differences between a first value and a second value. The first value may be a probability of having correctly, according to output values of samples of the new holdout set, assigned the samples of the new holdout set to individual leaf nodes based on input values of the holdout set. The second value may be unity.

In some embodiments, the method 300 further includes computing a measure of variability based on the samples assigned to the leaf nodes of the base ensemble of binary decision trees. The measure of variability may be at least one of variance, standard deviation, range, and interquartile range.

### Example Problem Setup

Machine learning is a form of learning by example. An example data set upon which a machine learning system is configured to operate may be represented by data set [symbol] ={(x₁, y₁), . . . , (x_{N}, y_{N})}. Each pair of data variables (x, y)∈ [symbol] may be drawn from an underlying probability distribution so that [symbol] is a sample. Each input x may be a tuple with elements that are real or categorical, ordered, or not ordered. Each respective response y may also be real or categorical.

Based on the data, the present methods and systems may estimate a response y from any input x. Estimation of the response y may include estimating an empirical distribution p that approximates Pr(Y|X). A point estimate may then be derived from p. For a real-valued or ordered categorical response, a natural choice of such point estimate may be mean_{y} p(y|x), the conditional mean of y given x based on the empirical distribution p. For an unordered categorical response, a point estimate chosen may be argmax_{y} p(y|x), i.e., the most probable value of y given x.

### Binary Trees

A binary tree has nodes, beginning with the root node, which nodes have binary splits of the form x⁽ⁱ⁾≥t, where i indexes an element of the tuple x. A data set may start at the root node, and elements thereof may be split into two groups according to an evaluation of an inequality associated with the root node. Elements satisfying the inequality may move to a subsequent node along, e.g., a right-side branch, and elements not satisfying the inequality may move to a subsequent node along, e.g., a left branch. Subsets of the data set are thus formed, and elements of these subsets may proceed down the tree in a manner resembling the aforementioned moves from the root node, according to evaluations of inequalities at each subsequent node, until termination at the leaf nodes.

Leaf nodes thus acquire respective subsets of the data set based on x values of datums of the data set. Further, data of the original data set, and indeed the input space, are partitioned: each element (x, y) of the data set, or of the input space, lands in one and only one of the leaf nodes. An empirical distribution may be associated with each leaf node and elements of the data set landing therein. Namely, let Iⱼ={i:xᵢ∈node j} and Sⱼ={x:x∈node j}. Thus, a set Iⱼ contains data indices at node j, and Sⱼ is a subset of the input space that lands at node j. Now let I′(x)=I_{j:x∈S}_{ⱼ}, i.e., a set of data indices for the node in which x falls. Further, let p′(y|x)=avg_{i∈I′(x)}1_{{y}_{ᵢ}_{}}(y), where 1 denotes an indicator function. Hence, mean_{y} p′(y|x) is an average of {yᵢ, i∈I′(x)}, the y values of a subset of the data set at the node where x lands. It also follows that argmax_{y} p′(y|x) is a response y that occurs most frequently in the subset of the data set at the node where x lands. As further described hereinbelow, such a probability mass function p′ is a building block in an empirical distribution p of a machine learning model.

### Example Data Set

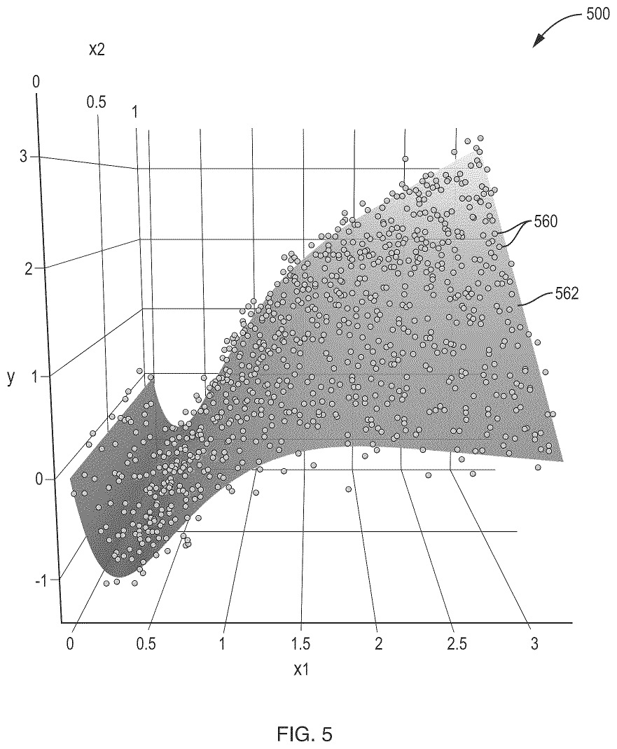

FIG. 5 is a three-dimensional plot 500 of an example dataset, shown as a collection of point markers 560, with a corresponding surface 562 determined to be a true fit to the dataset. Specifically, the surface 562 represents E(Y|X) based on the underlying distribution that generated the data of the dataset. The true fit surface 562 of the plot 500 serves as a baseline for comparison with surface estimates of empirical distributions resulting from an application of the model described herein to the original dataset. In the example dataset, each input x is a tuple with two elements, indexed as x⁽¹⁾ and x⁽²⁾ and shown along axes likewise labeled x1 and x2 in the plot 500. Other example data sets including tuples of orders greater than two may also be processed by the model described herein, although such tuples become more difficult to illustrate using plots such as the plot 500.

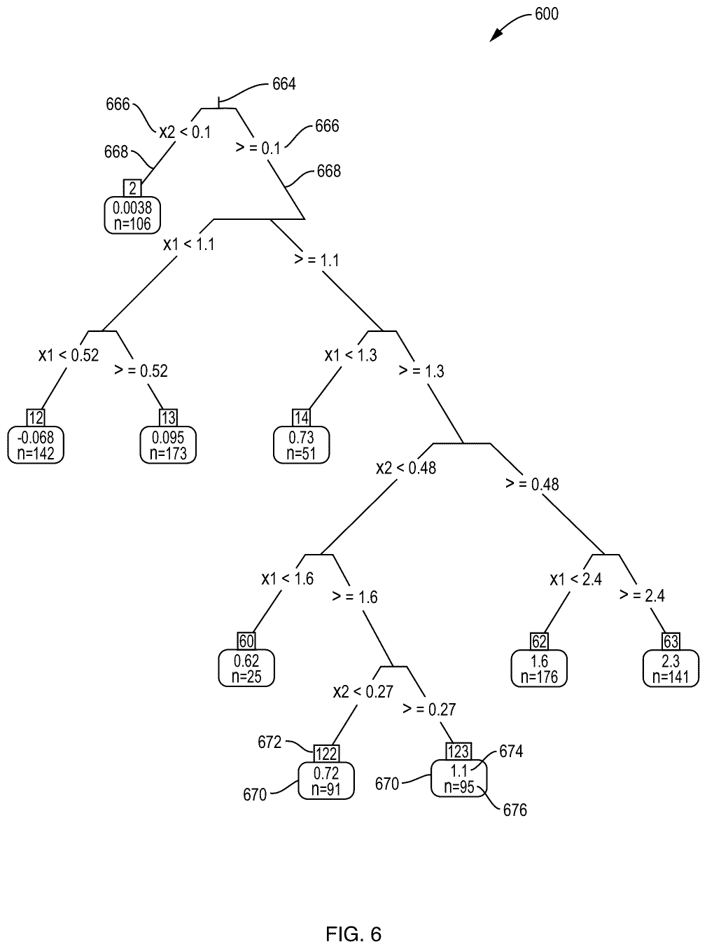

FIG. 6 is a graphical depiction 600 of a binary tree fit to the example data set of plot 500 by partitioning 664 the data set according to inequalities 666, as in the foregoing description of such partitioning. The partitioning 664 thus creates branches 668 leading eventually to leaf nodes 670. Each leaf node 670 includes a unique numeric identifier 672. It can be seen that each leaf node includes an average output value 674, or y-value, of the data set, i.e., mean_{y} p′(y|x) as introduced hereinabove. Each leaf node 670 further includes a quantity n of elements 676 settled within that leaf node 670.

In an example as shown in FIG. 6, the unique numeric identifier of a root node may be 1, and child nodes of the root node, represented as issuing to the left and right of the root node, may have unique numeric identifiers of 2 and 3 respectively. In general, given a parent node with a unique numeric identifier of i, a child node represented as issuing to the left therefrom may be given a unique numeric identifier of 2*i, and a child node represented as issuing to the right from the parent node may be given a unique numeric identifier of 2*i+1.

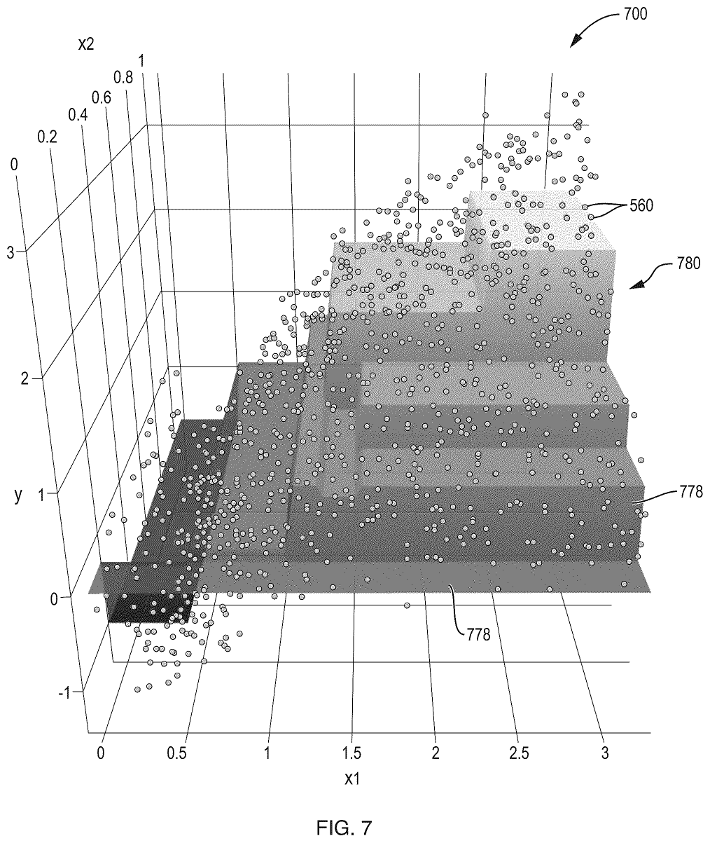

FIG. 7 is a three-dimensional plot 700 of facets 778 corresponding to individual leaf nodes 670 of the binary tree depicted 600 in FIG. 6, for the data set shown by point markers 560 as introduced in FIG. 5. Each of the facets 778 together comprise a piece-wise constant three-dimensional surface 780.

### Tree Ensemble

A suitable model for approximating a probability distribution of a response to a given input, based on data set [symbol] may be an ensemble of binary trees, i.e., a tree ensemble. Let [symbol] ={tₖ} be a collection of binary trees as defined hereinabove. Denote by pₖ′ an empirical distribution associated with each binary tree in the aforementioned collection thereof. An overall distribution p associated with such an ensemble of binary trees may be given by p(y|x)=avgₖ pₖ′(y|x). Point estimates, and anything else that can be derived from a probability distribution, may be obtained in the usual way from this empirical distribution.

### Optimization

Following is described an example embodiment of a process wherein a choice of trees [symbol] is optimized. In such an embodiment, a training set is defined as ε⊂ [symbol] . An optimization technique employed in such embodiments is based on minimizing generalization error. For an ordered response variable, generalization error is given by

H( [symbol] )= [symbol] _{\ε}(yᵢ−mean_{y}p(y|xᵢ; [symbol] ,ε))²

where a point estimate explicitly depends upon the data subset ε and tree ensemble [symbol] . In such an embodiment, the generalization error is the total squared error between the response and the tree ensemble estimate over a holdout set [symbol] \ε.

For a categorical response variable, the generalization error may be given by

H( [symbol] )= [symbol] ε(1−p(yᵢ|xᵢ; [symbol] ,ε))²

In words, such a generalization error may be computed as the sum of squared differences between the probability of a correct classification of a given data element, and 1.

In such embodiments, a minimization of the generalization error may be performed using a Gibbs sampler. Such a minimization procedure may include the following steps:
1) Choose an initial tree ensemble T randomly
2) Choose a training set E randomly
3) Propose a change to the initial tree ensemble T
4) Evaluate Gibbs energy H as defined hereinabove for the initial tree ensemble with the chosen training set, and for the proposed changed tree ensemble with the chosen training set. Implement the proposed change to [symbol] . Note that the probability of correct classification increases with the improvement in Gibbs energy, as the generalization error is likewise reduced.
5) Repeat 2)-4).

### Multi-Level Tree Construction

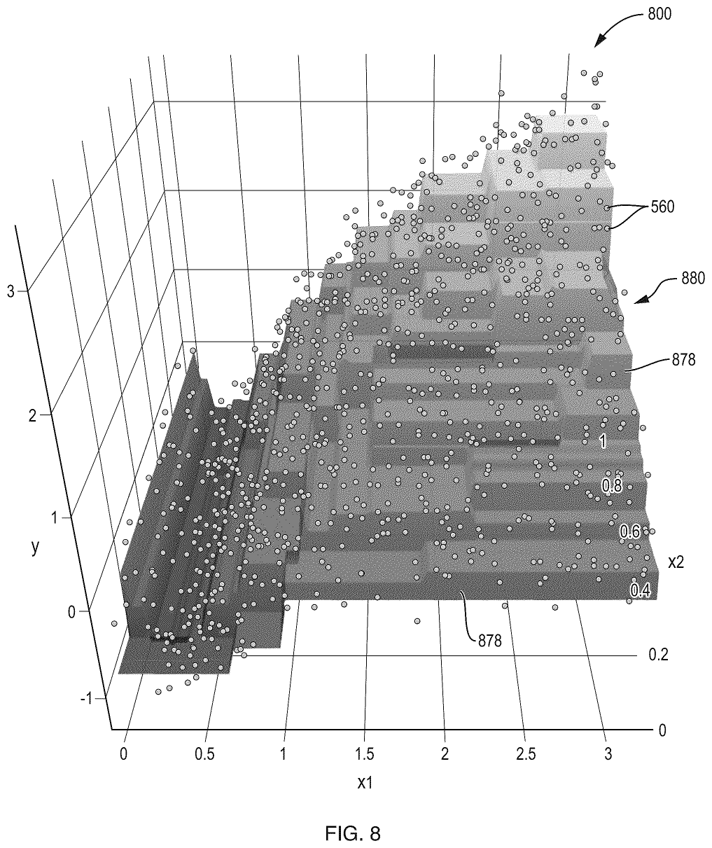

A central question in using trees in estimation is how deep to make the tree. When should one stop splitting nodes? FIG. 8 is a three-dimensional plot 800 of facets 878 corresponding to individual leaf nodes of a binary tree that is deeper, i.e, comprises more layers, than the binary tree depicted 500 in FIG. 5. Point markers 560 are shown in FIG. 8 for the same data set as was introduced in FIG. 5. The plot 800 thus provides an estimation surface 880 for such a deeper binary tree.

The number of facets 878 to the surface 880 increases as the number of leaf nodes increases with tree depth. Indeed, the tree depth aspect of the binary tree model is a Riemann approximation, so with increasing tree depth, a rich set of functions can be approximated arbitrarily well. However, the binary tree model is based purely on a fixed set of data: as the number of facets 878 or leaf nodes 670 increases, there are fewer data points remaining at the node level with which to perform the described estimations. As the number of data points available at the node level is reduced, a noise effect can be observed in the model. Therefore, it becomes advantageous to fit a family of tree ensemble models indexed by tree depth and to select the depth at which generalization error is smallest, so as to strike an appropriate balance between tree depth and estimation noise with regard to generalization error.

In some embodiments, a tree ensemble is optimized at a shallow depth first, and lower branches are subsequently added incrementally. In such embodiments, a level l of tree depth is a level of a tree for which #Iⱼ<Lₗ for all leaf nodes j, wherein tree depth is built according to a decreasing sequence {Lₗ}. Restated, an overall tree depth may be a function of a number of training samples present in the largest node in the tree. By decreasing, in steps, the threshold for the number of training samples allowed to be present in the largest node, the tree depth (and, thus, complexity of the tree) can be increased.

A Model with Minimal Generalization Error

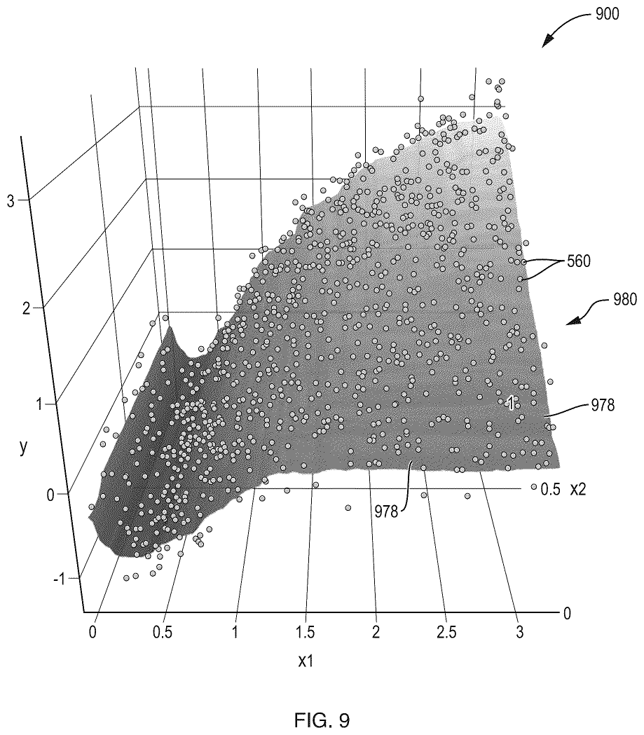

FIG. 9 is a three-dimensional plot 900 of facets 978 corresponding to individual leaf nodes of an ensemble of binary trees that is still deeper than that of FIG. 8, but wherein the depth of the tree does not exceed a depth at which generalization error begins to increase due to estimation noise. Individual facets 978 become difficult to distinguish, as the resulting surface 980 represents a relatively accurate approximation of the data set represented by point markers 560.

While example embodiments have been particularly shown and described, it will be understood by those skilled in the art that various changes in form and details may be made therein without departing from the scope of the embodiments encompassed by the appended claims.

What is claimed is:

1. A computer-implemented method of training a machine learning model, the method comprising:
accessing a given machine learning model, the given machine learning model being formed based on a data mapping, the data mapping associating an input data point to a respective output data point;
from empirical data of interest for the given machine learning model, estimating a probability distribution;
automatically improving the estimated probability distribution using a generalization error, said improving being by a processor:
modeling the probability distribution using a decision tree ensemble, and
optimizing choice of tree in the decision tree ensemble by minimizing the generalization error,
the improved estimated probability distribution determining weights or parameters for the given machine learning model resulting in a trained model.

2. A method as claimed in claim 1 wherein estimating the probability distribution includes:
from the empirical data, obtaining a data set including a plurality of samples and storing the data set within a computer memory element; and
further configuring the processor to:
(i) determine randomly a base ensemble of binary decision trees; and
wherein automatically improving the estimated probability distribution includes further configuring the processor to:
(ii) determine and thereby propose a changed ensemble of randomized binary decision trees;
(iii) randomly sort samples of the plurality of samples within the computer memory element to define a training set and a holdout set complementary to the training set; and
(iv) evaluate using the training and holdout sets from step (iii) a base generalization error of the proposed base ensemble of binary decision trees;
(v) evaluate using the training and holdout sets from step (iii) a new generalization error of the proposed changed ensemble of binary decision trees;
(vi) in response to the new generalization error being less than the base generalization error designate, within the computer memory element, the proposed changed ensemble of binary decision trees as the new base ensemble of binary decision trees; and
(vii) repeat steps (ii)-(vi) according to a pre-determined constant number of training iterations, thereby optimizing the base ensemble of binary decision trees based on generalization error thereof, the optimized base ensemble of binary decision trees representing the automatically improved estimated probability distribution.

3. A method as claimed in claim 2 wherein respective randomized binary decision trees of the base ensemble thereof have a number of decision layers that is influenced by a pre-determined maximum number of samples allowed within leaf nodes of the randomized binary decision trees, the method further including configuring the processor to:
(viii) repeat steps (ii)-(vi) wherein the number of decision layers is influenced by a reduced maximum number of samples allowed within the leaf nodes of the binary decision trees, such that the proposed changed ensemble of randomized binary decision trees has a greater number of decision layers than the number of decision layers in the base ensemble of randomized binary decision trees.

4. A method as claimed in claim 3 further including configuring the processor to:
(ix) recursively repeat step (viii) until the computed new generalization error is smaller than the designated base generalization error for a pre-determined number of iterations, thereby increasing the number of decision layers in the base ensemble of randomized binary decision trees until an optimized generalization error is reached.

5. A method as claimed in claim 2 further including:
before respectively designating the proposed changed ensemble of binary decision trees as the base ensemble of binary decision trees, configuring the processor to store the base ensemble of binary decision trees as elements of an entry in a historical database within the computer memory element; the historical database configured to retain a pre-determined number of entries; and
configuring the processor to respectively designate the elements of a selected entry as the base ensemble of binary decision trees, thereby returning the probability model to a previously estimated state for further optimization therefrom.

6. A method as claimed in claim 2 wherein proposing a base ensemble of randomized binary decision trees includes:
(a) defining a binary decision tree having a root node, a plurality of branches and a plurality of decision nodes corresponding to the plurality of branches, the decision nodes including a plurality of intermediate decision nodes and a plurality of leaf nodes, the branches initially radiating from the root node and mutually connected by the intermediate decision nodes, pairs of the branches corresponding to pairs of opposing evaluations of respective inequalities instructive of a comparison between any sample from the training set and a random threshold value assigned to the given pair of branches;
(b) assigning a given training sample from the training set to individual leaf nodes of the plurality of leaf nodes by passing the given training sample from the root node along selected branches determined by the evaluations of the respective inequalities for the given training sample at successive selected branches;
(c) repeating step (b) for each sample in the training set; and
(d) repeating steps (b) and (c) until a pre-determined number of decision trees has been met, thereby producing a base ensemble of randomized binary decision trees.

7. A method as claimed in claim 6 wherein evaluating a base generalization error includes:
(a) computing respective point estimates for each leaf node of the plurality of leaf nodes of a given randomized binary decision tree based on the samples from the training set assigned to the leaf node;
(b) assigning a given test sample from the holdout set to individual leaf nodes of the plurality of leaf nodes by passing the given test sample from the root node along selected branches determined by evaluations of the respective inequalities for the given test sample at successive selected branches;
(c) repeating steps (a) and (b) for each test sample in the holdout set;
(d) repeating steps (a) through (c) for each randomized binary decision tree in the base ensemble thereof; and
(e) computing a sum, over each randomized binary decision tree in the base ensemble thereof, of squared differences between a first value and a second value, the first value being a probability of having correctly, according to output values of samples of the holdout set, assigned the samples of the holdout set to individual leaf nodes based on input values of the holdout set, the second value being unity.

8. A method as claimed in claim 6 wherein proposing a changed ensemble of randomized binary decision trees includes:
(a) defining a change to a randomly selected random threshold value of a given pair of branches;
(b) assigning a given training sample from the new training set to individual leaf nodes of the plurality of leaf nodes by passing the given training sample from the root node along selected branches determined by the evaluations of the respective inequalities for the given training sample at successive selected branches;
(c) repeating step (b) for each sample in the training set, and
(d) repeating steps (b) and (c) until the pre-determined number of decision trees has been met, thereby producing a changed ensemble of randomized binary decision trees.

9. A method as claimed in claim 8 wherein evaluating a new generalization error includes:
(a) computing respective point estimates for each leaf node of the plurality of leaf nodes of a given randomized binary decision tree based on the samples from the new training set assigned to the leaf node;
(b) assigning a given test sample from the new holdout set to individual leaf nodes of the plurality of leaf nodes by passing the given test sample from the root node along selected branches determined by evaluations of the respective inequalities for the given test sample at successive selected branches;
(c) repeating steps (a) and (b) for each test sample in the new holdout set;
(d) repeating steps (a) through (c) for each randomized binary decision tree in the proposed changed ensemble thereof, and
(e) computing a sum, over the leaf nodes of each randomized binary decision tree in the proposed changed ensemble thereof, of squared differences between a first value and a second value, the first value being a probability of having correctly, according to output values of samples of the new holdout set, assigned the samples of the new holdout set to individual leaf nodes based on input values of the holdout set, the second value being unity.

10. A method as claimed in claim 6 further including computing a measure of variability based on the samples assigned to the leaf nodes of the base ensemble of binary decision trees.

11. A method as claimed in claim 10 wherein the measure of variability is at least one of variance, standard deviation, range, and interquartile range.

12. A machine learning system, the system comprising:
a processor and a computer memory element with computer-executable software instructions and a machine learning model stored thereon, the instructions, when loaded by the processor, causing the processor to be configured to:
access the machine learning model stored in the computer memory element, the machine learning model being formed based on a data mapping, the data mapping associating an input data point to a respective output data point;
from empirical data of interest for the machine learning model, estimate a probability distribution;
automatically improve the estimated probability distribution using a generalization error by:
modeling the probability distribution using a decision tree ensemble, and
optimizing choice of tree in the decision tree ensemble by minimizing the generalization error,
the improved estimated probability distribution determining weights or parameters for the machine learning model resulting in a trained model.

13. A system as claimed in claim 12 wherein:
stored within the computer memory element is a data set obtained from empirical data, the data set including a plurality of samples;
wherein the processor is configured to estimate the probability distribution by:
(i) determining randomly a base ensemble of binary decision trees; and
wherein the processor is configured to automatically improve the estimated probability distribution by:
(ii) determining and thereby proposing a changed ensemble of randomized binary decision trees;
(iii) randomly sorting samples of the plurality of samples within the computer memory element to define a training set and a holdout set complementary to the training set; and
(iv) evaluating using the training and holdout sets from step (iii) a base generalization error of the proposed base ensemble of binary decision trees;
(v) evaluating using the training and holdout sets from step (iii) a new generalization error of the proposed changed ensemble of binary decision trees;
(vi) if the new generalization error is less than the base generalization error designating, within the computer memory element, the proposed changed ensemble of binary decision trees as the new base ensemble of binary decision trees; and
(vii) repeating steps (ii)-(vi) according to a pre-determined constant number of training iterations, thereby optimizing the base ensemble of binary decision trees based on generalization error thereof, the optimized base ensemble of binary decision trees representing the automatically improved estimated probability distribution.

14. A system as claimed in claim 13 wherein respective randomized binary decision trees of the base ensemble thereof have a number of decision layers that is influenced by a pre-determined maximum number of samples allowed within leaf nodes of the randomized binary decision trees, and wherein the processor is further configured to:
(viii) repeat steps (ii)-(vi) wherein the number of decision layers is influenced by a reduced maximum number of samples allowed within the leaf nodes of the binary decision trees, such that the proposed changed ensemble of randomized binary decision trees has a greater number of decision layers than the number of decision layers in the base ensemble of randomized binary decision trees.

15. A system as claimed in claim 14 wherein the processor is further configured to:
(ix) recursively repeat step (viii) until the computed new generalization error is smaller than the designated base generalization error for a pre-determined number of iterations, thereby increasing the number of decision layers in the base ensemble of randomized binary decision trees until an optimized generalization error is reached.

16. A system as claimed in claim 13 wherein the processor is further configured to:
before respectively designating the proposed changed ensemble of binary decision trees as the base ensemble of binary decision trees, storing the base ensemble of binary decision trees as elements of an entry in a historical database within the computer memory element; the historical database configured to retain a pre-determined number of entries; and
respectively designating the elements of a selected entry as the base ensemble of binary decision trees, thereby returning the probability model to a previously estimated state for further optimization therefrom.

17. A system as claimed in claim 13 wherein the processor is configured to propose a base ensemble of randomized binary decision trees by:
(a) defining a binary decision tree having a root node, a plurality of branches and a plurality of decision nodes corresponding to the plurality of branches, the decision nodes including a plurality of intermediate decision nodes and a plurality of leaf nodes, the branches initially radiating from the root node and mutually connected by the intermediate decision nodes, pairs of the branches corresponding to pairs of opposing evaluations of respective inequalities instructive of a comparison between any sample from the training set and a random threshold value assigned to the given pair of branches;
(b) assigning a given training sample from the training set to individual leaf nodes of the plurality of leaf nodes by passing the given training sample from the root node along selected branches determined by the evaluations of the respective inequalities for the given training sample at successive selected branches;
(c) repeating step (b) for each sample in the training set; and
(d) repeating steps (b) and (c) until a pre-determined number of decision trees has been met, thereby producing a base ensemble of randomized binary decision trees.

18. A system as claimed in claim 17 wherein the processor is configured to evaluate a base generalization error by:
(a) computing respective point estimates for each leaf node of the plurality of leaf nodes of a given randomized binary decision tree based on the samples from the training set assigned to the leaf node;
(b) assigning a given test sample from the holdout set to individual leaf nodes of the plurality of leaf nodes by passing the given test sample from the root node along selected branches determined by evaluations of the respective inequalities for the given test sample at successive selected branches;
(c) repeating steps (a) and (b) for each test sample in the holdout set;
(d) repeating steps (a) through (c) for each randomized binary decision tree in the base ensemble thereof; and
(e) computing a sum, over each randomized binary decision tree in the base ensemble thereof, of squared differences between a first value and a second value, the first value being a probability of having correctly, according to output values of samples of the holdout set, assigned the samples of the holdout set to individual leaf nodes based on input values of the holdout set, the second value being unity.

19. A system as claimed in claim 17 wherein the processor is configured to propose a changed ensemble of randomized binary decision trees by:
(a) defining a change to a randomly selected random threshold value of a given pair of branches;
(b) assigning a given training sample from the new training set to individual leaf nodes of the plurality of leaf nodes by passing the given training sample from the root node along selected branches determined by the evaluations of the respective inequalities for the given training sample at successive selected branches;
(c) repeating step (b) for each sample in the training set, and
(d) repeating steps (b) and (c) until the pre-determined number of decision trees has been met, thereby producing a changed ensemble of randomized binary decision trees.

20. A system as claimed in claim 19 wherein the processor is configured to evaluate a new generalization error by:
(a) computing respective point estimates for each leaf node of the plurality of leaf nodes of a given randomized binary decision tree based on the samples from the new training set assigned to the leaf node;
(b) assigning a given test sample from the new holdout set to individual leaf nodes of the plurality of leaf nodes by passing the given test sample from the root node along selected branches determined by evaluations of the respective inequalities for the given test sample at successive selected branches;
(c) repeating steps (a) and (b) for each test sample in the new holdout set;
(d) repeating steps (a) through (c) for each randomized binary decision tree in the proposed changed ensemble thereof, and
(e) computing a sum, over the leaf nodes of each randomized binary decision tree in the proposed changed ensemble thereof, of squared differences between a first value and a second value, the first value being a probability of having correctly, according to output values of samples of the new holdout set, assigned the samples of the new holdout set to individual leaf nodes based on input values of the holdout set, the second value being unity.
